(19) United States
(12) Patent Application Publication
(10) Pub. No.: US 2012/0234347 A1
(43) Pub. Date: Sep. 20, 2012

(54) MOUNTABLE FLOSS DISPENSER INCLUDING A REPLACEABLE SPOOL

(76) Inventor: Johnny Stephens, Atlanta, GA (US)

(21) Appl. No.: 13/342,200

(22) Filed: Jan. 3, 2012

Related U.S. Application Data
(60) Provisional application No. 61/449,649, filed on Mar. 5, 2011.

(51) Int. Cl. A61C 15/00

(52) U.S. Cl. 132/321

(57) ABSTRACT

A nondisposable dental care device that includes a front cover unit and a back cover unit. The front cover unit includes a cutter mechanism on a top portion of the front cover unit and grip levers on the side of the unit. The back cover unit includes two openings for attaching the dental care device to the wall. The front cover unit and the back cover unit form a spool-less nondisposable floss dispenser housing unit.

### CROSS-REFERENCE TO RELATED APPLICATIONS

The application claims the benefit of priority of U.S. Provisional Application Ser. No. 61/449,649 filed on Feb. 18, 2011, the disclosure of which is incorporated herein by reference in its entirety.

### FIELD OF INVENTION

The present disclosure relates to dental accessories. In particular, the present disclosure relates to an environmental friendly dental floss dispenser.

### BACKGROUND OF THE INVENTION

Conventional floss dispensers include a spool of dental floss and the floss dispenser is disposed of when the dental floss runs out. The spool inside the floss dispenser is not refillable, and therefore the user must discard the empty floss dispenser and obtain a new floss dispenser when the floss runs out. The constant disposal of the floss dispenser has a negative impact on the environment and does not help to sustain the planet or the nation's attempt to GO GREEN.

Furthermore, conventional floss dispensers are usually located in a drawer or cabinet. This lack of accessibility and visibility fails to encourage and promote regular oral hygiene, particularly for kids.

The dental care device disclosed herein overcomes the disadvantages of conventional floss dispensers.

### SUMMARY OF THE INVENTION

The present invention includes a front cover unit including a cutter mechanism on a top portion of the front cover unit, and a back cover unit including an internal elongated storage holder. The front cover unit and the back cover unit attach to one another forming a spool-less nondisposable floss dispenser housing unit.

### BRIEF DESCRIPTION OF THE DRAWINGS

FIG. 1 is an exemplary illustration of an open configuration of a housing unit.

FIG. 2 is an exemplary illustration of a closed configuration of a housing unit.

FIG. 3 is an exemplary interior illustration of a front cover unit.

FIG. 4 is an exemplary interior illustration of a back cover unit.

FIG. 5 is an exemplary exterior illustration of a back cover unit.

FIG. 6 is an exemplary illustration of a spool of floss.

### DETAILED DESCRIPTION

The present invention is a dental care device, which promotes regular oral hygiene by visual appearance and location. The dental care device is mountable to a wall surface, and can be designed in many forms or shapes to encourage regular flossing. The device includes a nondisposable spool-less housing unit, one or more replaceable and interchangeable spools of dental floss, and a mechanism for dispensing the floss.

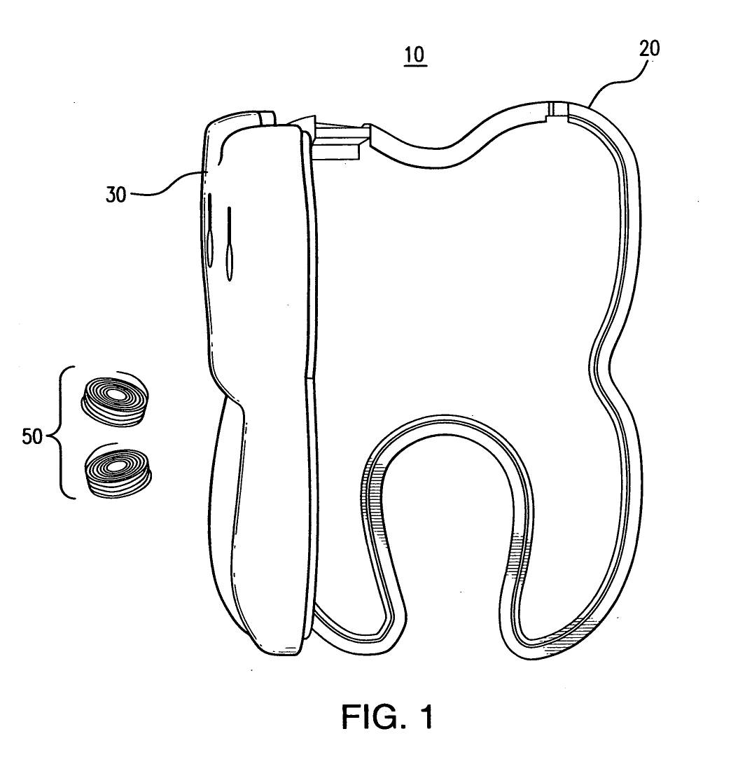

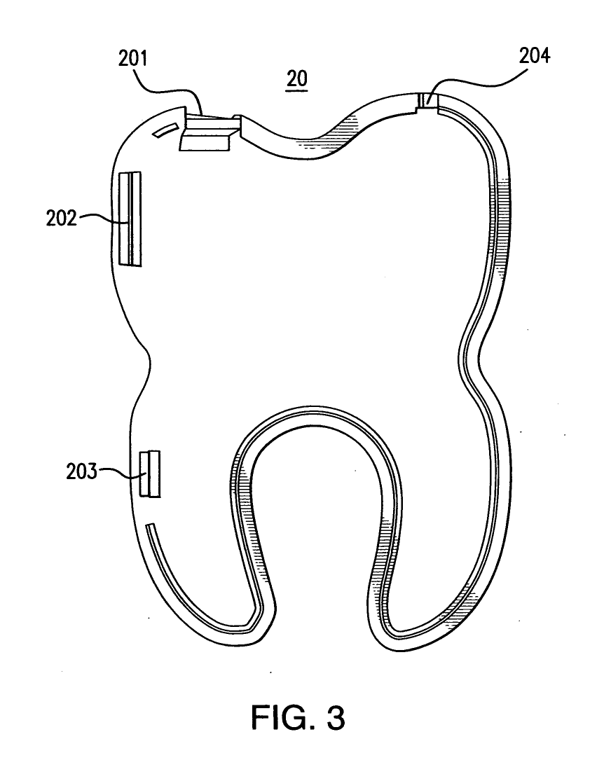

As illustrated in FIG. 1, the dental care device 10 includes a front cover unit 20, a back cover unit 30 and housing unit 40 (shown in FIG. 2). The housing unit is formed when the front cover unit and the back cover unit are attached to one another along all sides. The front cover unit and back cover unit are permanently attached along one side by two hinges (not shown). The dental care device also includes one or more replaceable spools of dental floss 50.

Housing unit 40 includes an open and closed configuration. FIG. 1 illustrates an open configuration and FIG. 2 illustrates a closed configuration of the housing unit. In the closed configuration, an opening is formed on a top portion of the housing unit. The opening is used to dispense a coil of floss from one or more floss units contained within the housing unit. Further, the top portion of the housing unit includes a cutter for cutting the coil of floss dispensed from the opening of the housing unit.

The housing unit 40 can be designed in any shape or form, which aids in promoting regular flossing. For example, the housing unit illustrated in FIG. 1 and FIG. 2, is in the shape of a tooth, which may be aesthetically pleasing to a particular age group. The aesthetically pleasing shape of the unit aids in the effort to influence a user in that age group to floss. The shape of the housing unit can be, for example, a football, doll, animal, building, etc.

Further, housing unit 40 can be of any size and/or dimension sufficient to house one or more spools of floss.

Housing unit 40 is reusable for an unlimited amount of time (i.e. nondisposable). When a spool of floss is empty, the unit can be replaced with a new spool of floss.

Front cover unit 20 is a plastic mold and, as illustrated in FIG. 3, includes cutter mechanism 201, first grip lever 202, second grip lever 203, and opening 204. The cutter mechanism is a piece of metal, which establishes the cutter on the top portion of the housing unit for cutting a coil of floss. The first grip lever and second grip lever are used to open and close the housing unit by attaching and detaching the front cover unit to/from back cover unit 30.

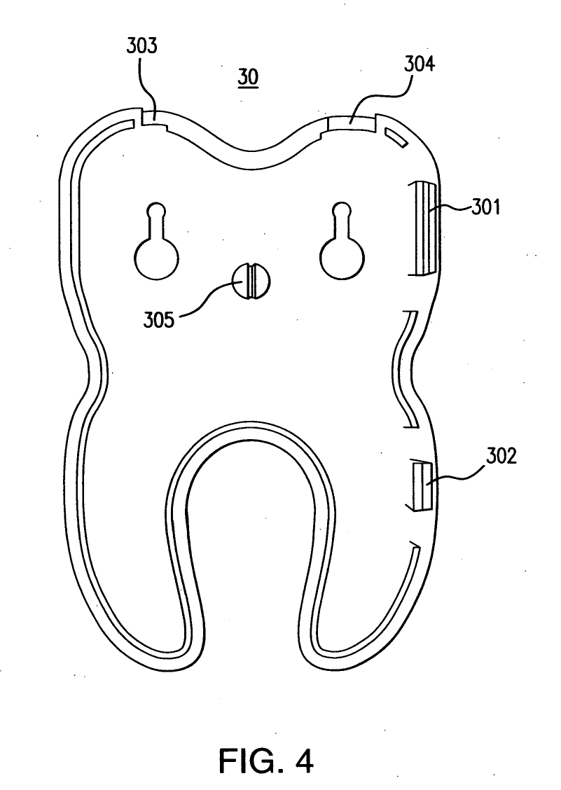

Back cover unit 30 is a plastic mold and, as illustrated in FIG. 4, the interior of the back cover unit includes first lever connector 301, second lever connector 302, opening 303, cutter holder 304 and elongated storage holder 305. The first lever connector and second lever connector connect with the first grip lever 202 and second grip lever 203 on front cover unit 20 to open and close the housing the unit. Opening 303 connects with opening 204 on the front cover unit to form an opening on the top portion of the housing unit. The cutter holder encloses cutter mechanism 201 on the front cover unit.

The elongated storage holder 305 holds a spool of floss. While the figure only shows one elongated storage holder, the back cover unit may include more than one elongated storage holder to store other spools of floss. Plural storage holders allow the housing unit to store more than one spool of floss. Thus, a housing unit can be shared by multiple users, where each user uses a different type of floss. Further, a single user may want to use two different types of flosses interchangeably. The increased storage provides flexibility.

The size of the elongated storage holder 305 is a proprietary size sufficient to allow a spool of floss to fit thereon without falling off.

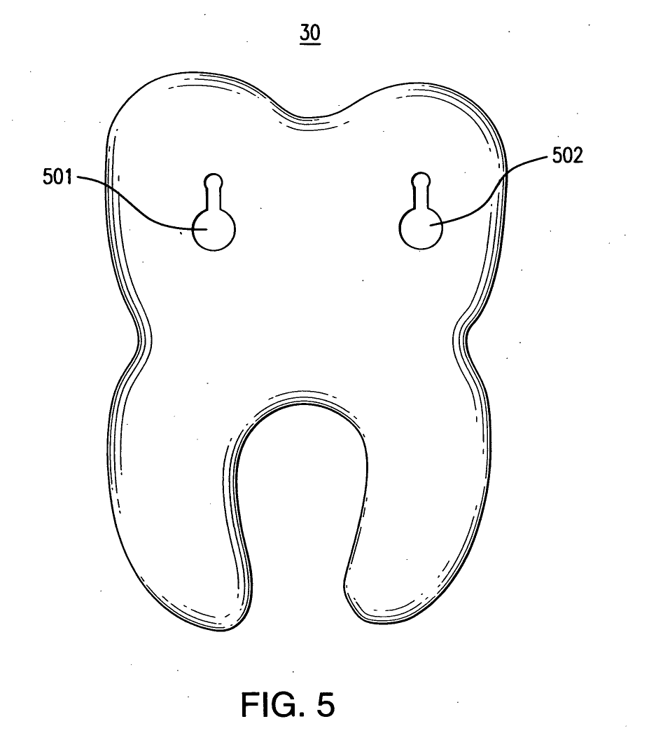

The exterior of the back cover unit 30 is illustrated in FIG. 5, and it includes two openings 501 and 502. The openings are used to attach housing unit 40 to a wall surface. The openings include an attachment for attaching the housing unit to a wall. The attachment may include, for example, suction cups, screws or any suitable device for mounting the housing unit to the wall.

The one or more spools of floss 50 can include different flavors and/or textures. For example, the floss texture can be ultra high molecular weight polyethylene (UHMW), teflon, or expanding nylon. The flavor of the floss may include, for example, mint or cinnamon flavoring. Furthermore, the floss may include teeth whitening materials.

The size and diameter of the one or more spools of floss 50 are non-standard. Each spool of floss has a proprietary size and diameter. As illustrated in FIG. 6, the spool has an outer diameter of 10.86 mm, an inner diameter of 7.91 mm. The thickness of the spool is 1.47 mm and the height of the spool is 9.98 mm.

While the front cover unit 20, back cover unit 30 and housing unit 40 are illustrated as tooth shaped, it should be appreciated that the shape of the front cover, back cover and housing unit can be any shape and color. Furthermore, the front cover unit, back cover unit and housing unit can be made of any appropriate materials, such as, for example, polymers, metals or a combination thereof.

With respect to the above description, it is to be realized that the optimal dimensional relationships for the parts described in the present disclosure, to include variations in size, materials, shape, form, function and manner of operation, assembly and use, are deemed readily apparent and obvious to one skilled in the art, and all equivalent relationships to those illustrated in the drawings and described herein are intended to be encompassed by the present disclosure.

These descriptions are not inclusive and many other modifications and variations will be apparent to someone of ordinary skill in the art with construction skills in the related arts. Together these descriptions and accompanying illustrations seek to provide an explanation of the basic principles of the embodiment and its application.

Moreover, while illustrative embodiments of the invention have been described herein, further embodiments can include equivalent elements, modifications, omissions, combinations (e.g., of aspects across various embodiments) adaptations and/or alterations as would be appreciated by those skilled in the art based on the present disclosure.

What is claimed:

1. A dental care device comprising:
a front cover unit including a cutter mechanism on a top portion of the front cover unit; a back cover unit including one or more internal elongated storage holders, and wherein the front cover unit and the back cover unit attach to one another forming a spool-less nondisposable floss dispenser housing unit.

2. The dental care device of claim 1, further comprising one or more replaceable spools of floss.

3. The dental care device of claim 2, wherein each elongated storage holder stores a replaceable spool of floss.

4. The dental care device of claim 1, wherein the housing unit has an open and closed configuration.

5. The dental care device of claim 4, wherein a top portion of the housing unit includes an opening when the housing unit is in a closed configuration.

6. The dental care device of claim 1, wherein the front cover unit includes a first and second grip lever.

7. The dental care device of claim 6, wherein the first and second grip levers are used to open and close the housing unit.

8. The dental care device of claim 1, wherein the back cover unit includes two openings.

9. The dental care device of claim 8, wherein the two openings on the back cover unit are used to attach the dental care device to a wall surface.

10. The dental care device of claim 9, wherein the two openings include suction cups for attachment of the dental care device to the wall.

11. The dental care device of claim 9, wherein the two openings include screws for attachment of the dental care device to the wall.

12. The dental care device of claim 2, wherein the one or more spools of floss are of proprietary size and diameter.

13. The dental care device of claim 2, wherein the one or more spools of floss are of differing flavors from the group consisting of mint and cinnamon.

14. The dental care device of claim 2, wherein the one or more spools of floss are of different textures from the group consisting of ultra high molecular polyethylene, teflon, and expanding nylon.

15. The dental care device of claim 1, wherein the housing unit has an aesthetically appealing shape to promote regular oral hygiene.

16. A spool of floss for use with a dental care device comprising:
a hollow cylinder of floss with a outer diameter of 10.86 mm, a thickness of 1.47 mm and a height of 9.98 mm.

17. A spool of floss as claimed in claim 16, wherein the floss is of a flavor from a group consisting of mint and cinnamon.

18. A spool of floss as claimed in claim 16, wherein the floss is of a texture from a group consisting of ultra high molecular polyethylene, teflon, and expanding nylon.
